(19) United States
(12) Patent Application Publication
(10) Pub. No.: US 2006/0000323 A1
(43) Pub. Date: Jan. 5, 2006

(54) Carpet extractor

(76) Inventors: Drue A. Kehl, Murray, UT (US); Gordon Case, South Jordan, UT (US)

Correspondence Address: Drue A. Kehl;WESTERN WORLD INVESTMENT, INC., 6152 South Stratler, Murray, UT, 84107, US

(21) Appl. No.: 11/209,575

(22) Filed: Aug. 23, 2005

Related U.S. Application Data
(63) Continuation-in-part of application No. 10/867,339, filed on Jun. 14, 2004, now abandoned.

(51) Int. Cl. B25G 1/01

(52) U.S. Cl. 81/489

(57) ABSTRACT

The invention involves a carpet extractor for moving rolls of carpets and other tubular elements. The carpet extractor includes an elongate member to which the other components of the carpet extractor are coupled. A plurality of extendable members is linked to the elongate member and adapted to engage the inner surface of the tubular element. An engagement mechanism is also linked to the extendable members and configured to actuate the extendable members so as to facilitate the movement of rolls of carpet. The engagement mechanism can include one or more translational, cam members linked to the extendable members and which facilitate actuation of the extendable members to selectively engage a roll of carpet.

### CROSS-REFERENCE TO RELATED APPLICATIONS

This application is a continuation-in-part of U.S. patent application Ser. No. 10/867,339, filed Jun. 14, 2004, and entitled CARPET RETRACTOR, which is incorporated herein by reference in its entirety.

### BRIEF SUMMARY OF THE INVENTION

The present invention relates to a carpet extractor which allows a user to quickly and efficiently move a roll of carpet when a single end of the carpet roll is exposed. The carpet extractor can also facilitate displacement of carpet rolls using a forklift or other equipment. The carpet extractor includes an elongate member, a plurality of extendable members, and an extension mechanism.

According to one aspect of the present invention, the plurality of extendable members is coupled to a distal end of an elongate member. The extendable members can be selectively extended or retracted to engage or disengage the inner surface of a roll of carpet. The extension mechanism is linked to the plurality of extendable members and facilitates extension and retraction of the extendable members. According to one aspect of the present invention, the extension mechanism includes a cam member received and housed within the elongate member and a second elongate member linking the cam member to a handle member.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a perspective view of an exemplary embodiment of a carpet extractor;

FIG. 2 illustrates a cross-section view of the distal and proximal ends of the carpet extractor of FIG. 1;

FIG. 3A illustrates an extendable member of the carpet extractor in a retracted position;

FIG. 3B is a front view of the carpet extractor illustrating the extendable members in a retracted position inside a tubular element;

FIG. 4A illustrates an extendable member of the carpet extractor in an extended position;

FIG. 4B is a front-view of the carpet extractor illustrating the extendable members in an extended position engaging an inner surface of the tubular element;

FIG. 5 illustrates a perspective view of the carpet extractor being utilized in connection with a roll of carpet;

FIG. 6 illustrates a perspective view of the carpet extractor;

FIG. 7 illustrates an enlarged view of the carpet extractor as shown in FIG. 6 illustrating the upper and lower portion of the carpet extractor;

FIG. 8 shows a cut-away view of the upper portion of the carpet extractor;

FIG. 9A illustrates the gripping members of the carpet extractor in a retracted position;

FIG. 9B is a front view of the carpet extractor illustrating the gripping members in a retracted positioned inside a roll of carpet;

FIG. 10A shows the gripping members of the carpet extractor in an extended position;

FIG. 10B is an enlarged view of an engagement surface of the gripping members;

FIG. 10C illustrates the gripping members of the carpet extractor in an extended position engaging the inside of a carpet roll; and

FIG. 11 shows an isometric view of the carpet extractor inside a roll of carpet.

### DETAILED DESCRIPTION OF THE PREFERRED EMBODIMENTS

The present invention is directed to a carpet extractor adapted to move rolls of carpet. The principles of the invention, however, are not limited to rolls of carpet. It will be understood that, in light of the disclosure, the carpet extractor herein can be successfully used in connection with other types of rolled material, or other tubular mechanisms and structures.

In an exemplary embodiment, the carpet extractor includes an elongate member, a plurality of extendable members linked to the elongate member and an extension mechanism linked to the plurality of extendable members and the elongate member. The extension mechanism is configured to selectively extend or retract the plurality of extendable members. Additionally, the plurality of extendable members is adapted to engage an inner surface of a tubular element, such as a roll of carpet, when the plurality of extendable members is extended.

In one embodiment, the extension mechanism includes a cam member linked to the plurality of extendable members and a second elongate member linking the cam member to a handle member. Movement of the handle member extends or retracts the plurality of extendable members to engage the tubular element. In an alternative embodiment, the extension mechanism includes a collar slideably coupled to the elongate member and a cable coupled to the collar. In this embodiment, the collar is adapted to engage the plurality of extendable members, thereby selectively extending or retracting the plurality of extendable members. By tensioning the cable, the collar is displaced; sufficient displacement of the collar causes the plurality of extendable members to extend.

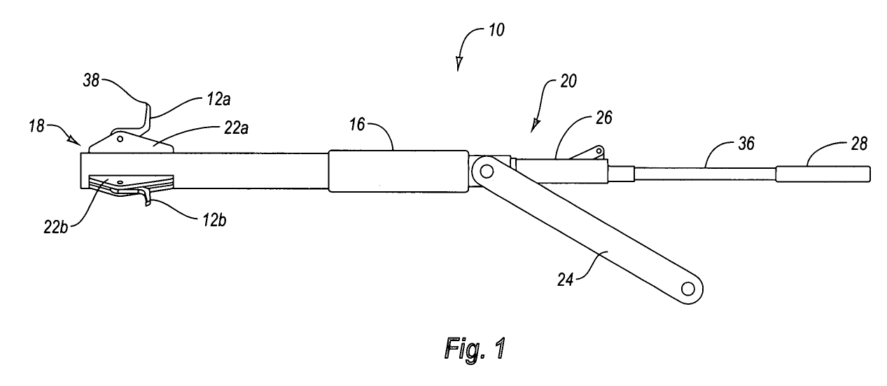

FIG. 1 illustrates a carpet extractor 10 according to one aspect of the invention. Carpet extractor 10 is adapted to allow a user to quickly and efficiently move a tubular element, such as a roll of carpet, by engaging an inner surface of a tube on which the carpet roll is mounted. In particular, carpet extractor 10 facilitates movement of a carpet roll when only a single end of the carpet roll is exposed. Additionally, carpet extractor 10 can facilitate the utilization of a forklift, unloading machine, or other equipment or machinery in connection with moving a carpet roll or other tubular structure.

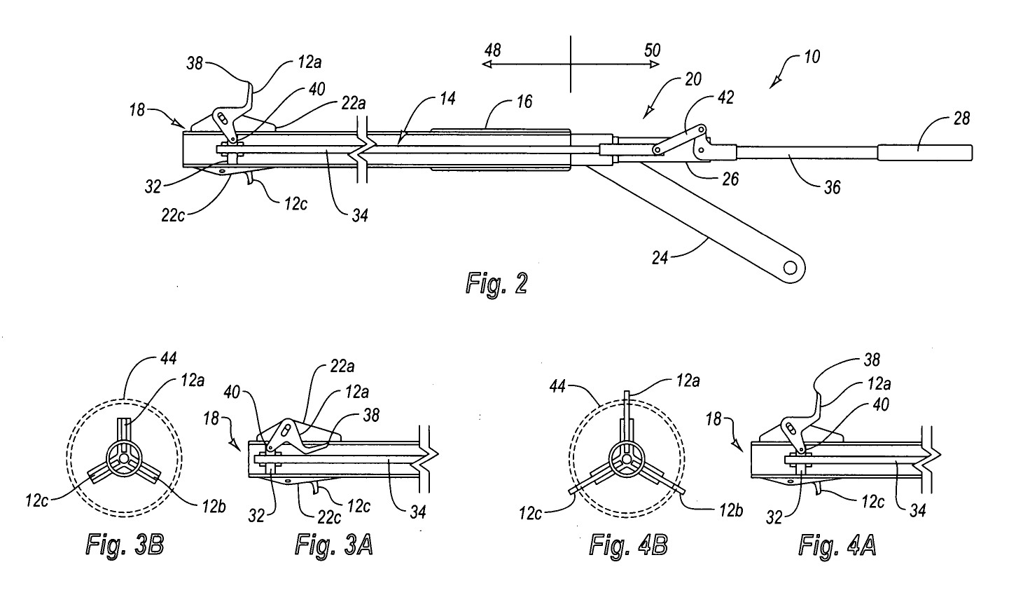

Illustrated in FIG. 1 is a carpet extractor 10 having a plurality of extendable members 12a-c for engaging the inner surface of a tubular element. In the illustrated embodiment, extendable members 12a-c and an extension mechanism 14 (see FIG. 2) are operatively linked to an elongate member 16. Extendable members 12a-c are configured to have a plurality of operative positions. For example, extendable members 12a-c can have expanded and/or retracted positions, and can be selectively moved therebetween. In one embodiment, extendable members 12a-c engage the inner surface of a tubular element when in the extended position. Additionally, and as described in more detail hereafter, extension mechanism 14 can be linked to extendable members 12a-c and configured to selectively extend or retract plurality of extendable members 12a-c.

The configuration of extendable members 12a-c, extension mechanism 14 and elongate member 16 allows a user to quickly and efficiently move tubular elements. Elongate member 16 serves as a framework on which additional components of carpet extractor 10 are positioned. In the illustrated embodiment, for example, elongate member 16 comprises a hollow cylindrical member with a distal end 18 and a proximal end 20. Elongate member 16 is fabricated to have sufficient structural strength to accommodate the weight of a tubular element such as a carpet roll, and can be comprised of a rigid material such as metal, composite, durable polymer, wood, or a combination thereof.

As illustrated, extendable members 12a-c can be pivotally linked to the distal end 18 of elongate member 16. In the illustrated embodiment, for example, extendable members 12a-c are pivotally linked to elongate member 16. Extendable members 12a-c include a distal end 38 and a proximal end 40. Distal end 38 of extendable members 12a-c is adapted to selectively engage the inner surface of a tubular element. As distal end 38 of extendable members 12a-c extend, distal end 38 engages the inner surface of the tubular element, thereby creating a frictional, interference fit with the tubular element. In one embodiment, distal end 38 is pointed, while in an alternative embodiment, distal end 38 is rounded. In this manner, in one exemplary implementation, such as where distal end 38 is pointed, as extendable members 12a-c are extended, distal end 38 of extendable members 12a-c punctures the tubular element. In an alternative embodiment, extendable members 12a-c are extended to, and push against, the inner surface of the tubular element without piercing the tubular element. As will be appreciated, the engagement of the inner surface by extendable members 12a-c allows a user to handle carpet extractor 10, thereby also allowing a user to quickly and efficiently move the tubular element.

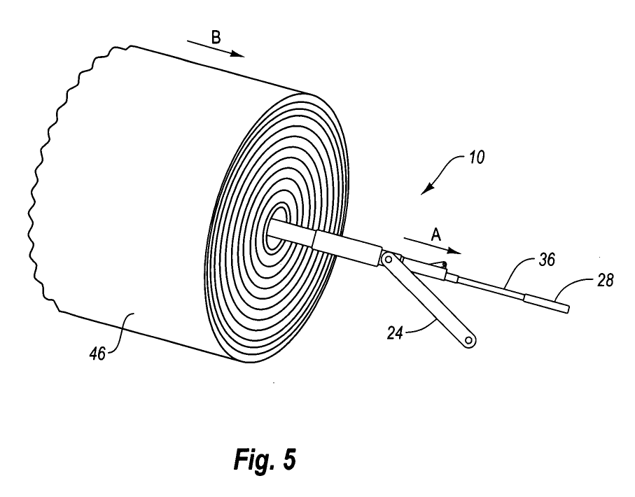

In the illustrated embodiment, and as more clearly illustrated in FIGS. 3B and 4B, three extendable members 12a-c are provided as part of carpet extractor 10, each positioned one hundred and twenty degrees apart. As will be appreciated by a person having ordinary skill in the art, however, any number of extendable members may be utilized without departing from the scope and spirit of the invention. For example, in an alternative embodiment, four extendable members are provided as part of carpet extractor 10, each positioned ninety degrees apart. In still other embodiments, only two extendable members may be utilized, and may be spaced one hundred and eighty degrees apart. It will also be appreciated that while equal angular spacing between the extendable members facilitates a substantially equal distribution of weight and forces between the tubular element and carpet extractor 10, this feature is not necessary and the plurality of extendable members have an unequal angular distribution. To support the weight of the tubular element, extendable members 12a-c comprise rigid members made of a metal. It will be appreciated, however, that extendable members 12a-c may be comprised of other rigid materials. Other representative materials suitable to form extendable members 12a-c include rigid plastic, composite, hard wood, or some other suitably strong material.

In the illustrated embodiment, extendable members 12a-c are linked to elongate member 16 utilizing brackets 22a-c. Brackets 22a-c are configured to link extendable members 12a-c to elongate member 16. As illustrated, brackets 22a-c can comprise a pair of substantially parallel plates sufficiently spaced apart to allow extendable members 12a-c, respectively, to be positioned therebetween. Brackets 22a-c can comprise metal or other materials including, for example, composites, woods, or polymeric materials. Extendable members 12a-c are rotatably coupled to brackets 22a-c, so as to pivot with respect to brackets 22a-c. In this embodiment, extendable members 12a-c are rotably coupled to brackets 22a-c via a hinge-type pin joint. The hinge-type pin joint may further, as described in more detail hereafter, be a slot-and-pin assembly, thus allowing extendable members 12a-c to both pivot and translate with respect to brackets 22a-c. Brackets 22a-c are attached to elongate member 16, and attachment may be accomplished in a variety of ways. For example, brackets 22a-c may be integrally formed with elongate member 16. In other embodiments, brackets 22a-c are attached to elongate member 16 by welding, adhesives, or mechanical fasteners. For example, rivets, bolts, clamps, epoxy, or the like are contemplated as suitable attaching means.

Carpet extractor 10 can further include a connection member 24, a handle coupling member 26, and a grip 28 coupled to elongate member 16. Connection member 24 is comprises a rigid member rotatably linked to proximal end 20 of elongate member 16, and is configured to be coupled to a piece of equipment, such as a forklift, to facilitate removal and movement of a tubular element. To hold up during removal and movement of the tubular element, connection member 24 can be a metal plate, or it may comprise any other suitable material sufficient to support the weight of the tubular element.

Carpet extractor 10 can comprise a handle coupling member 26. Handle coupling member 26 comprises a rigid metal housing member which is coupled to proximal end 20 of elongate member 16. Handle coupling member 26 can, in one embodiment, be welded to elongate member or by coupled in any other suitable method. For example, in alternative embodiments, handle coupling member 26 can be coupled to elongate member 16 with an epoxy, with threaded connectors, with a detent pin, or in some other method. As will be described in more detail with respect to FIG. 2, handle coupling member 26 is configured to receive a portion of handle member 36 therein, and pivotally couple the received portion thereto such that handle member 36 can rotate. Rotation or movement of handle member 36 facilitates the extension or retraction of extendable members 12a-c. For example, in the illustrated embodiment, as handle member 36 is rotated to a position collinear with elongate member 16, extendable members 12a-c are in an expanded position.

In the illustrated embodiment, grip 28 is positioned at proximal end 20 of elongate member 16, and surrounds a portion of handle member 36. Grip 28 is configured to allow a user to handle carpet extractor 10 in an easy and convenient manner. For example, the placement of grip 28 at proximal end 20 of carpet extractor 10 allows a user to easily handle and maneuver carpet extractor 10, as well as an engaged tubular element. Grip 28 can also be configured to allow a user to handle carpet extractor 10 comfortably. For example, grip 28 can comprise a resilient material to provide a comfortable feel to the user of carpet extractor 10 as handle member 36 is used. Resilient materials such as rubber, modified rubber, neoprene, foam, or soft elastomers are exemplary materials suitable to provide such comfort.

Now referring to FIG. 2, a cross-sectional view of an exemplary carpet extractor 10 is illustrated and depicts the manner in which extendable members 12a-c can be actuated by extension mechanism 14. As previously noted, extension mechanism 14 can be configured to selectively extend or retract extendable members 12a-c. In the illustrated embodiment, extension mechanism 14 comprises a cam member 32 and a second elongate member 34 that links cam member 32 to handle member 36. Cam member 32 comprises a rigid member that is configured to be received by, and housed within, elongate member 16. The configuration of cam member 32 makes cam member 32 capable of translational movement within elongate member 16. In this embodiment, cam member 32 is pivotally linked to proximal end 40 of extendable members 12a-c. In this manner, extendable members 12a-c are capable of rotational movement relative to cam member 32. In the illustrated embodiment, extendable members 12a-c are further linked to brackets 22a-c, respectively, and cam member 32 such that translational movement of cam member 32 causes rotation of extendable members 12a-c, thereby extending or retracting extendable members 12a-c.

Further, extendable members 12a-c are configured such that translational movement of cam member 32 moves distal end 38 of extendable members 12a-c in either a distal direction 48 or proximal direction 50. For example, when cam member 32 is moved in the distal direction 48, extendable members 12a-c retract as proximal end 40 of extendable members 12a-c moves in the distal direction 48 and distal end 38 moves in the proximal direction 50. Conversely, when cam member 32 translates in the proximal direction 50, extendable members 12a-c extend as distal end 38 of extendable members 12a-c moves in the distal direction 48, and proximal end 40 moves in the proximal direction 50. Accordingly, cam member 32 facilitates the selective extension and retraction of extendable members 12a-c by a user selectively translating cam member 32 in either the distal 48 or proximal 50 direction.

Second elongate member 34 is adapted to facilitate the selective extension and retraction of extendable members 12a-c. In the illustrated embodiment, second elongate member 34 comprises a rod made of a metal or other rigid material. One end of second elongate member 34 is coupled to cam member 32, while an opposing end is linked to handle member 36. In this manner, handle member 36 is also linked to cam member 32. Additionally, the link between second elongate member 34 and cam member 32 and/or handle member 36 may be either direct or indirect. For example, second elongate member 34 can be linked to handle member 36 by an intermediate linking member 42. In the illustrated embodiment, intermediate linking member 42 comprises a rigid member made of metal, and is configured to rotate relative to both second elongate member 34 and handle member 36. Intermediate linking member 42 and extendable members 12a-c are thus, each configured to rotate with respect to second elongate member 34 intermediate linking member 42, thereby forming a compound linkage.

The compound linkage can further act as an engagement mechanism to link extendable members 12a-c to handle member 36. In the illustrated embodiment, the compound linkage is formed by second elongate member 34 being pivotally coupled, either directly or indirectly, to intermediate linking member 42 and extendable members 12a-c. Additionally, the linkage may be further compounded where handle member 36 is pivotally coupled to intermediate linking member 42 and/or where cam member 32 is pivotally coupled to extendable members 12a-c.

As will be appreciated by one having ordinary skill in the art, the compound linkage between handle member 36 and cam member 32 facilitates movement of cam member 32 and extendable members 12a-c, thereby performing, at least partially, means for engaging extendable members 12a-c with a tubular element. In the illustrated embodiment, for example, while handle member 36 is substantially collinear to elongate section 16, extendable members 12a-c are extended to engage a tubular element. However, as the illustrated handle member 36 is moved or rotated in a counterclockwise direction, intermediate linking member 42 moves in the distal direction 48. Consequently, second elongate member 34 and cam member 32 also translate in the distal direction 48. As more clearly illustrated in FIG. 3A, this translational movement of cam member 32 results in selective retraction of extended extendable members 12a-c.

Additionally, in the illustrated embodiment, handle coupling member 26 comprises a substantially tubular element which encloses at least a portion of the compound linkage. Further, second elongate member 34, intermediate linking member 42, and handle member 36 can each be received at least partially into handle coupling member 26. In this manner, one or more hinge-pins or other connections allowing for a compound linkage can be encased within handle coupling member. In the illustrated embodiment, handle member 36 is pivotally coupled to the interior of handle coupling member 26. In this manner, handle coupling member 26 can be rotated to engage the compound linkage. In particular, rotation of handle member 36 causes a corresponding rotation of intermediate linking member 42 and the consequent movement of the remaining compound linkage.

It will be appreciated that the illustrated embodiment is exemplary only, and that other engagement mechanisms are within the scope of the present invention. For example, linking member 42 and handle member 36 may be configured such that a clockwise motion of handle member 36 facilitates engagement of extendable members 12a-c. In other alternative embodiments, telescoping members or a cable and bearing assembly may replace one or more components of the compound linkage to facilitate extension and retraction of extendable members 12a-c and/or act as an engagement mechanism. In still other embodiments, handle member 26 may be secured to carpet extractor 10 within elongate member 16.

FIG. 3A illustrates a cross-sectional view of distal end 18 of elongate member 16 when extendable members 12a-c are in a retracted position. Extendable members 12a-c are rotably linked to cam member 32 by using a pivot pin connection. In addition, extendable members 12a-c are rotably linked to brackets 22a-c, respectively. In the illustrated embodiment, extendable members 12a-c are rotably linked to brackets 22a-c by use of a slot-and-pin assembly. The pin is a pivot pin and can be formed on, or secured to, brackets 22a-c. The slot may be formed in extendable members 12a-c, and may be substantially circular or elongate. An elongate slot facilitates both pivotal and translational movement of extendable members 12a-c with respect to brackets 22a-c. As will be appreciated, the pivotal and translational connection between brackets 22a-c and extendable members 12a-c, and the pivot pin connection between cam member 32 and extendable members 12a-c provides freedom for extendable members 12a-c to rotate. In this manner, extendable members 12a-c can be selectively rotated with respect to cam member 32 into a retracted position such as that illustrated in FIGS. 3A and 3B.

As can be understood from the illustrated embodiment, when cam member 32 is moved in the distal direction 48, extendable members 12a-c retract to the illustrated position and distal end 38 of extendable members 12a-c moves in the proximal direction 50. As more clearly illustrated in FIG. 3B, when extendable members 12a-c are in the retracted position, extendable members 12a-c do not engage the tubular member 44. Accordingly, carpet extractor 10 is not secured to tubular member 44, and a user may extract carpet extractor 10 from, or insert carpet extractor 10 into, tubular member 44 without substantial resistance.

FIG. 4A is a cross-sectional view of distal end 18 of elongate member 16, and illustrates extendable members 12a-c in an extended position as may be suitable to engage tubular member 44. To selectively position extendable members 12a-c in the illustrated extended position, cam member 32 can be moved in the proximal direction 50. Because of this translational movement, distal end 38 of extendable members 12a-c moves at least partially in the distal direction 48, while also extends outward. In this manner, and as illustrated in FIG. 4B, extendable members 12a-c engage tubular element 44 and can create an interference fit between tubular element 44 and extendable members 12a-c. As will be appreciated, particularly in light of the discussion hereafter, this engagement allows a user to manipulate tubular element 44 by using carpet extractor 10.

Now referring to FIG. 5, an exemplary embodiment is illustrated in which carpet extractor 10 is positioned within a carpet roll 46. When handle member 36 is rotated so as to be substantially collinear with elongate member 16, cam member 32 moves in the proximal direction 50 and distal end 38 of extendable members 12a-c moves in the distal direction 48 into an extended position. As previously described, when extendable members 12a-c are extended, distal ends 38 of extendable members 12a-c engage the inner surface of carpet roll 46, thereby securing carpet extractor 10 to carpet roll 46. As will be appreciated, when carpet extractor 10 then translates in the proximal direction 50, with extendable members 12a-c in an extended position engaging the inner surface of carpet roll 46, extendable members 12a-c tend to further engage carpet roll 46, and extendable members 12a-c do not retract.

A method of utilizing carpet extractor 10 to move a carpet roll 46 will now be described. A user rotates handle member 36 from the illustrated position, toward distal end 18 of elongate member 16, thereby moving linking member 42 toward distal end 18 of elongate member 16. Consequently, cam member 32 moves in the distal direction 48, and extendable members 12a-c move into a retracted position. The user can then position elongate member 16 within tubular element 44. By gripping grip 28, a user can then move handle member 36 away from distal end 18 of elongate member 16, and toward the position illustrated in FIG. 5. In this manner, extendable members 12a-c are moved into an extended position and engage the inner surface of carpet roll 46. When the user then moves carpet extractor 10 in the direction of arrow A, carpet roll 46 moves parallel to carpet extractor, and along arrow B. This is particularly useful where carpet roll 46 is stacked with other rolls, or otherwise positioned where only a single end of carpet roll 46 is exposed. To pull carpet roll 46 out and allow it to be moved, or to allow carpet to be removed therefrom, carpet extractor 10 can be inserted into the exposed end. Once inserted, a user can engage carpet roll 46 with extendable members 12a-c. Once engaged, the user can pull on carpet extractor 10 in the direction of arrow A, thereby pulling carpet roll 46 out from the stack.

To further facilitate movement of carpet roll 46, connection member 24 is coupled to carpet extractor 10. Connection member 24 may further be coupled or otherwise secured to a piece of equipment or machinery—such as a forklift—and the piece of equipment or machinery can then extract carpet roll 46. After extraction of carpet roll 46, connection member 24 can be uncoupled from the equipment. The user then again rotates handle member 36, as previously described, thereby moving extendable members 12a-c into a retracted position. Carpet extractor 10 can then be removed from carpet roll 46.

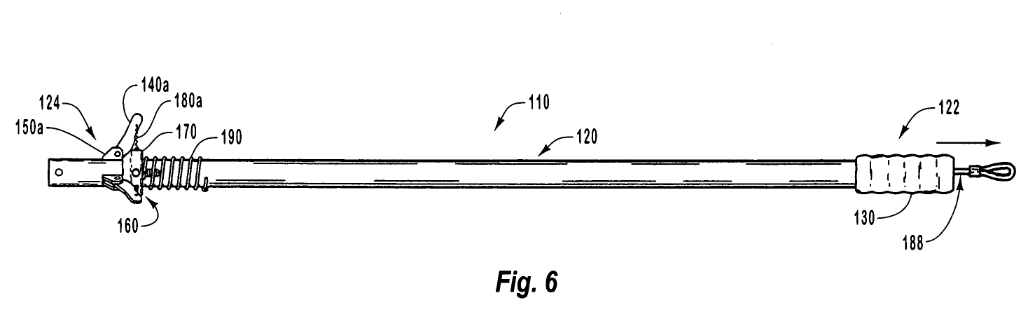

FIG. 6 is a perspective view illustrating a carpet extractor 110 according to one aspect of the invention. The carpet extractor 110 is adapted to allow a user to quickly and efficiently move carpet roll 194 by engaging the internal surface of a tube on which carpet roll 194 is rolled. This allows carpet roll 194 to be moved even when only a single end of carpet roll 194 is exposed. Additionally, carpet extractor 110 facilitates removal of carpet roll 194 utilizing a forklift, unloading machine, or other equipment. In the illustrated embodiment, carpet extractor 110 comprises an elongate member 120, gripping members 140a-c, and an extension mechanism 160.

Elongate member 120 provides the framework on which additional components of carpet extractor 110 are positioned. In the illustrated embodiment, elongate member 120 comprises a hollow cylindrical member comprised of metal, plastic, or wooden tube. Elongate member 120 comprises an elongate member lower portion 122 and an elongate member upper portion 124. A variety of types and configurations of elongate members can be utilized without departing from the scope and spirit of the invention. For example, in one embodiment, the elongate member comprises a solid support base on which additional components of the carpet extractor are positioned.

Gripping members 140a-c are coupled to elongate member upper portion 124. Gripping members 140a-c are adapted to selectively engage the inner surface of a tube on which carpet roll 194 is rolled. Gripping members 140a-c are configured to engage a roll 194 of carpet to allow a user to move roll 194 of carpet. In the illustrated embodiment, three gripping members 140a-c are provided as part of carpet extractor 110. However, any number of gripping members 140a-c can be utilized without departing from the scope and spirit of the invention. For example, in an alternative embodiment, four gripping members 140a-c are provided as part of carpet extractor 110. In the illustrated embodiment, gripping members 140a-c comprise rigid members pivotally coupled to the elongate member upper portion 124 in a hinged fashion. A variety of types and configurations of gripping members 140a-c can be utilized without departing from the scope and spirit of the invention. For example, in an alternative embodiment, gripping members 140a-c are hollow, rigid, lightweight composite projections. In another embodiment, the gripping members comprise solid projection members made of metal, plastic, or wood. Gripping members 140a-c are one example of extendable members.

In the illustrated embodiment, gripping members 140a-c are coupled to elongate member 120 utilizing gripping member brackets 150a-c. Gripping member brackets 150a-c comprise a hinge-type pin joint. Nevertheless, a variety of types and configurations of mechanisms can be utilized to couple gripping members 140a-c to the elongate member. For example in one embodiment, gripping member brackets 150a-c comprise a ball and socket joint. In alternative embodiment, gripping member brackets 150a-c comprise a compliant member joint.

In the illustrated embodiment, extension mechanism 160 is coupled to elongate member upper portion 124 adjacent gripping members 140a-c. Extension mechanism 160 allows a user to selectively extend and retract gripping members 140a-c so as to engage and disengage a carpet roll 194 to be moved. In the illustrated embodiment, extension mechanism 160 comprises a collar 170, a collar-biasing component 190, a plurality of gripping member-biasing components 180a-c, and a cable 188. As will be appreciated by those skilled in the art, a variety of types and configurations of extensions mechanisms can be utilized without departing from the scope and spirit of the present invention. For example, in one embodiment the extension mechanism is directly coupled to the gripping members. In an alternative embodiment, the extension mechanisms utilize intersecting elements connected to the gripping members to extend and retract the gripping members.

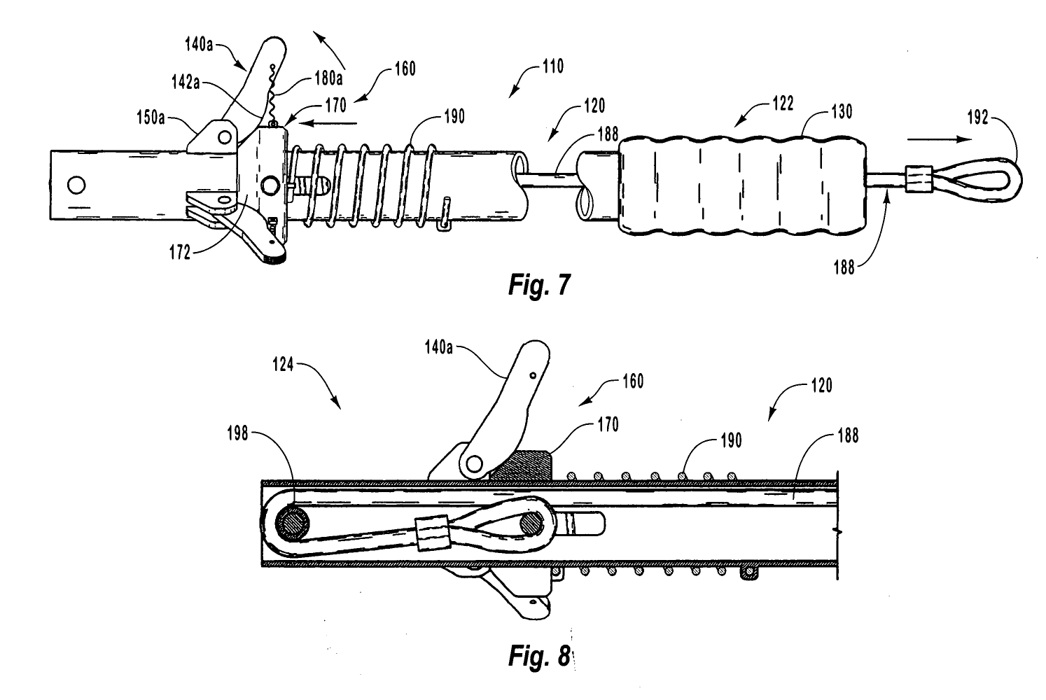

FIG. 7 illustrates the manner in which extension mechanism 160 extends and retracts gripping members 140a-c. Extension mechanism 160 comprises a collar 170, a collar-biasing component 190, a plurality of gripping member-biasing components 180a-c, and a cable 188. In the illustrated embodiment, collar 170 is slideably coupled to the elongate member upper portion 124 and co-axially orientated therewith. Collar 170 is configured to actuate gripping members 140a-c so as to facilitate the movement of a carpet roll 194. The gripping members 140a-c are actuated when a contact surface 172 of collar 170 engages the curvilinear profile 142a-c of gripping members 140a-c thus forcing gripping members 140a-c to extend outward. As will be appreciated by those skilled in the art, a variety of mechanisms for extending the gripping members can be utilized without departing from the scope and spirit of the present invention. Collar 170 is one example of an extension flange.

In the illustrated embodiment, elongate member 120 houses cable 188. When a user pulls an exposed engagement portion 192 of cable 188 collar 170 moves towards gripping member brackets 150a-c. Collar 170 contacts the curvilinear profile 142a-c of gripping members 140a-c extending gripping members 140a-c. When a user relaxes the tension on cable 188, collar-biasing component 190 urges collar 170 in the direction of elongate member lower portion 122. As collar-biasing component 190 urges collar 170 in the direction of elongate member lower portion 122, gripping member-biasing components 180a-c retract gripping members 140a-c.

FIG. 8 is a cross-sectional view of elongate member upper portion 124 illustrating the manner in which cable 188 facilitates extension and retraction of gripping members 140a-c. In the illustrated embodiment, elongate member 120 houses cable 188. Cable 188 is routed from collar 170 towards elongate member upper portion 124 where it is positioned over a roller bearing 198. Cable 188 continues back through elongate member 120 extending from elongate member lower portion 122.

Cable 188 is configured to actuate collar 170 and gripping members 140a-c causing extension of gripping members 140a-c so as to engage the inner surface 196 of a carpet roll 194 or other tubular element with which carpet extractor 110 is utilized. A variety of types and sizes of cables can be used without departing from the scope and spirit of the invention. Additionally, a variety of mechanisms can be utilized in place of roller bearing to facilitate proper actuating of collar 170 when a user pulls cable 188.

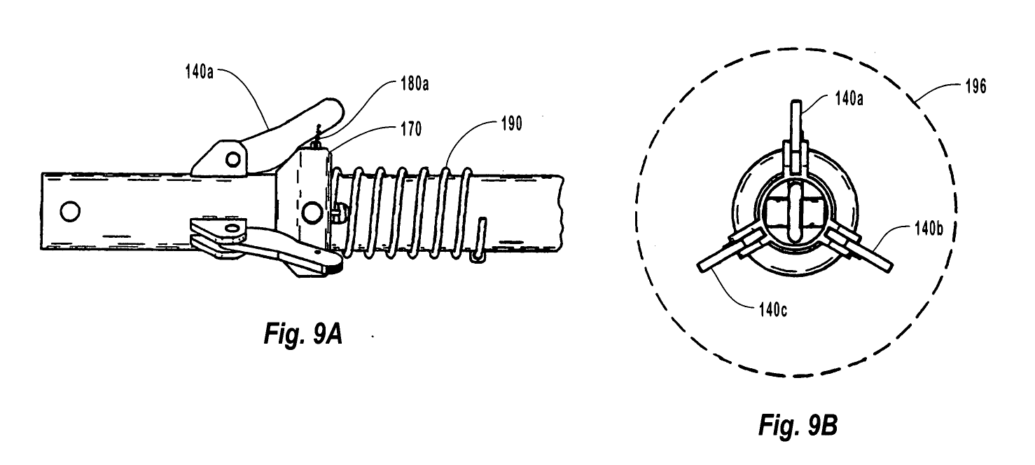

FIGS. 9A-B illustrate carpet extractor 110 in a disengaged or retracted orientation. Collar-biasing component 190 is coupled to collar 170 and elongate member 120. Collar-biasing component 190 influences collar 170 so as to facilitate retraction of gripping members 140a-c allowing the user to withdraw carpet extractor 110 from carpet roll 194. As previously discussed, when a user relaxes the pull on cable 188, collar-biasing component causes collar 170 to move in the direction of elongate member lower portion 122. In the illustrated embodiment collar-biasing component comprises a spring. As will be appreciated by those skilled in the art, a variety of types and configurations of collar-biasing components 190 can be utilized without departing from the scope and spirit of the present invention. For example, in an alternative embodiment, collar-biasing component 190 comprises an elastomeric material such as a rubberized or compressible foam flange.

In the illustrated embodiment, a plurality of gripping member-biasing components 180a-c are coupled to gripping members 140a-c and collar 170. The gripping member-biasing components 180a-c facilitate retraction of gripping members 140a-c. By allowing the user to retract gripping members 140a-c, gripping member-biasing components 180a-c allow the user to reposition or remove carpet extractor 110 relative to the inside carpet roll 194. While gripping member-biasing components 180a-c comprise wire members in the illustrated embodiment, a variety of types and configurations of gripping member biasing components can be utilized. Additionally, a variety of types and configurations of mechanisms can be utilized to retract gripping members 140a-c without departing from the scope and spirit of the present invention. For example, in one embodiment a plurality of resilient members are utilized. In alternative embodiment, the collar mechanism is adapted to directly retract the gripping members 140a-c. In yet another alternative embodiment, spring mechanisms or cable mechanisms are utilized. While in yet another embodiment, a plurality of hinged retraction mechanisms are coupled between the gripping members and the collar mechanism to retract gripping members 140a-c.

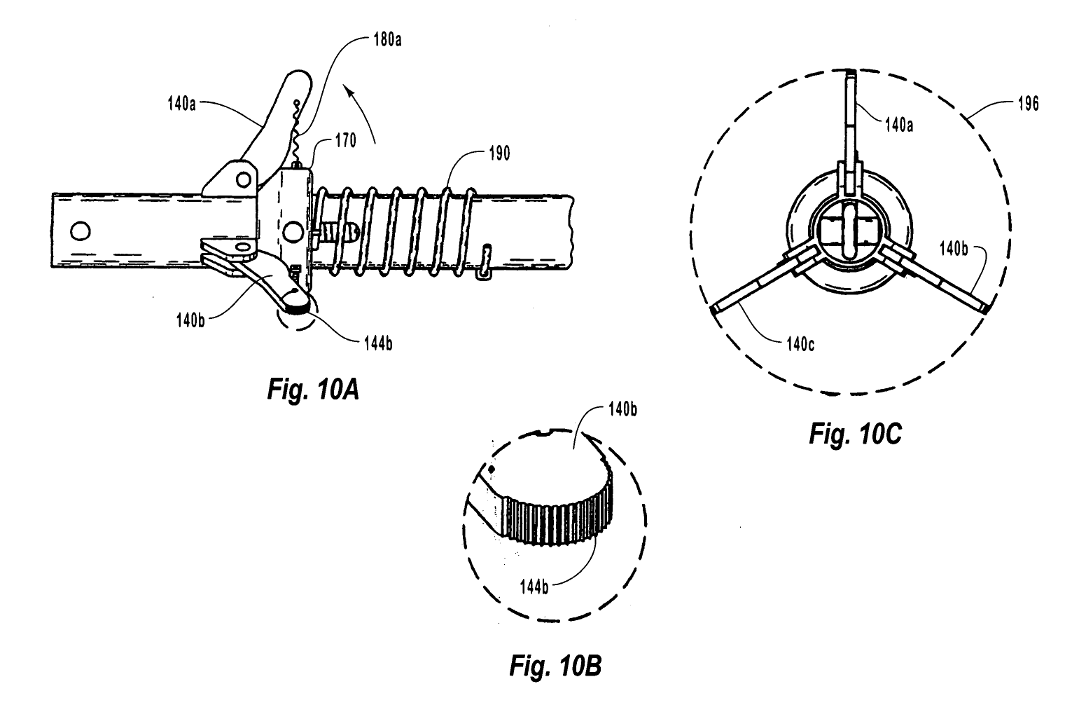

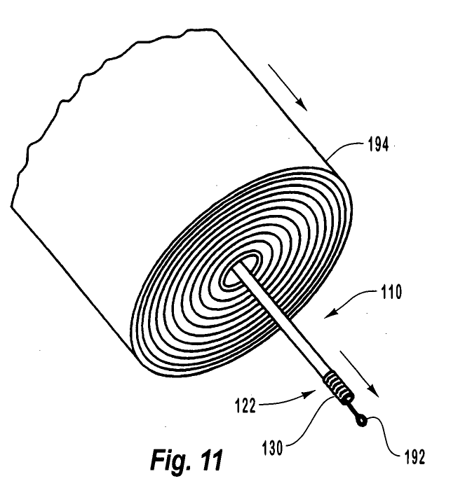

FIGS. 10A-C illustrate carpet extractor 110 in an extended orientation. As previously mentioned, a user extends gripping members 140a-c utilizing exposed engagement portion 192 of cable 188. Cable 188 displaces collar 170 allowing contact surface 172 to engage curvilinear profiles 142a-c of gripping members 140a-c. This results in the extension of gripping members 140a-c. As gripping members 140a-c extend outward, engagement surface 144a-c of gripping member 140a-c contacts the inner surface 196 of the carpet roll 194 causing engagement therewith. By contacting the inner surface 196 of carpet roll 194, sufficient friction is created to allow a user to selectively move carpet roll 194.

As shown in FIG. 11, carpet extractor 110 allows a user to move carpet roll 194. The user moves carpet roll 194 by inserting carpet extractor 110 into roll 194, extending gripping members 140a-c so as to engage the internal surface of carpet roll 194, and then pulling exposed engagement portion 192 of cable 188 or using a handle grip 130 coupled to elongate member lower portion 122 to slide carpet roll 194. As will be appreciated by those skilled in the art, as the user begins to move carpet roll 194, the force required to move carpet roll 194 strengthens the engagement by gripping members 140a-c on the internal surface of carpet roll 194.

A method of utilizing carpet extractor 110 to move a carpet roll 194 will now be described. The user inserts carpet extractor 110 in a retracted orientation into carpet roll 194. Once the carpet extractor 110 is positioned in carpet roll 194, the user actuates the gripping members 140a-c by pulling the exposed engagement portion 192 of the cable 188. This pulling action causes the collar 170 to contact curvilinear portions 142a-c of the gripping members 140a-c. This causes the gripping members 140a-c to extend outward. The user pulls the exposed engagement portion 192 of cable 188 until gripping members 140a-c extend sufficiently to engage the inner surface 196 of carpet roll 194. Once gripping members 140a-c engage inner surface 196 of carpet roll 194, the user can then manipulate handle grip 192 or exposed engagement portion 196 of cable 194 to displace carpet roll 194. To disengage carpet extractor 110 from carpet roll 194, the user releases the tension on exposed engagement portion 192 of cable 188 facilitating retraction of gripping members 140a-c.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for use in moving a tubular element, such as a carpet roll, the apparatus comprising:
an elongate member;
a plurality of extendable members linked to the elongate member, wherein the plurality of extendable members are configured to engage an inner surface of a tubular element;
a cam member linked to the plurality of extendable members and slidably received within the elongate member, wherein movement of the cam member in a first direction extends the plurality of extendable members, and movement of the cam member in a second direction retracts the plurality of extendable members; and
a second elongate member coupled to the cam member, the second elongate member configured to facilitate selective extension and retraction of the plurality of extendable members.

2. The apparatus as recited in claim 1, wherein the plurality of extendable members include a distal end and a proximal end.

3. The apparatus as recited in claim 2, wherein the cam member is linked to the proximal end of the plurality of extendable members.

4. The apparatus as recited in claim 3, wherein the proximal end of the plurality of extendable members is positioned within a portion of the first elongate member.

5. The apparatus as recited in claim 4, further comprising a handle member linked to the second elongate member, such that movement of the handle selectively extends or retracts the plurality of extendable members.

6. The apparatus as recited in claim 5, further comprising a connection member linked to the elongate member, wherein the connection member is configured to facilitate the movement of a tubular element when the plurality of extendable members are extended and engage an inner surface of the tubular element.

7. An apparatus configured to be received within and move a tubular element, the apparatus comprising:
an elongate member having a proximal end and a distal end;
a plurality of extendable members linked to the distal end of the elongate member, the plurality of extendable members having a proximal end and a distal end, wherein the distal end of the plurality of extendable members is adapted to engage an inner surface of a tubular element; and
a cam member slidably received within the elongate member and linked to the proximal end of the plurality of extendable members, the cam member being capable of movement in a proximal and distal direction, such that when the cam member is moved in the proximal direction, the distal end of the plurality of extendable members moves in the distal direction to thereby engage an inner surface of the tubular element.

8. The apparatus as recited in claim 7, further comprising a second elongate member linked to the cam member, wherein the second elongate member is configured to selectively extend or retract the plurality of extendable members.

9. The apparatus as recited in claim 8, further comprising a handle member linked to the second elongate member, such that movement of the handle member selectively extends or retracts the plurality of extendable members.

10. The apparatus as recited in claim 9, further comprising a connection member linked to the proximal end of the first elongate member, wherein the connection member is configured to facilitate the movement of the tubular element when the plurality of extendable members are extended and engage an inner surface of the tubular element.

11. The apparatus as recited in claim 7, wherein the proximal end of the plurality of extendable members is received within a portion of the elongate member.

12. The apparatus as recited in claim 7, wherein the cam member is housed within the elongate member.

13. An apparatus configured to be received within and move a tubular element, the apparatus comprising:
an elongate member having a proximal end and a distal end;
a plurality of extendable members linked to the distal end of the elongate member, the plurality of extendable members having a proximal end and a distal end, wherein the distal end of the plurality of extendable members is adapted to engage an inner surface of a tubular element and the proximal end of the plurality of extendable members is received within the elongate member; and
an extension mechanism configured to selectively extend or retract the plurality of extendable members, the proximal end of the plurality of extendable members being linked to the engagement mechanism such that movement of the engagement mechanism selectively extends or retracts the plurality of extendable members.

14. The apparatus as recited in claim 13, wherein the extension mechanism comprises a cam member that is slidably received within the elongate member.

15. The apparatus as recited in claim 14, wherein the cam member is linked to the proximal end of the plurality of extendable members.

16. The apparatus as recited in claim 15, wherein movement of the cam member in a proximal direction causes the distal end of the plurality of extendable members move in a distal direction and extend to engage an inner surface of a tubular element.

17. The apparatus as recited in claim 16, wherein the extension mechanism further comprises a second elongate member linking the cam member to a handle member.

18. The apparatus as recited in claim 17, wherein movement of the handle member extends or retracts the plurality of extendable members.

19. The apparatus as recited in claim 18, further comprising a connection member linked to the proximal end of the elongate member, wherein the connection member is configured to facilitate the movement of a tubular element when the plurality of extendable members are extended and engage an inner surface of the tubular element.

20. The apparatus as recited in claim 16, wherein the cam member is housed within the elongate member.

21. An apparatus configured to be received within and move a tubular element, the apparatus comprising:
an elongate member;
a plurality of extendable members linked to the elongate member, wherein the plurality of extendable members are configured to engage an inner surface of a tubular element; and
an engagement mechanism received within the elongate member and linked to the plurality of extendable members, wherein the engagement mechanism comprises a compound linkage configured to selectively extend and retract the plurality of extendable members.
